(19) United States
(12) Patent Application Publication
(10) Pub. No.: US 2020/0041729 A1
(43) Pub. Date: Feb. 6, 2020

(54) OPTICAL MODULE

(71) Applicant: FUJITSU COMPONENT LIMITED, Tokyo (JP)

(72) Inventors: Satoshi Moriyama, Tokyo (JP); Osamu Daikuhara, Tokyo (JP); Shinichiro Akieda, Tokyo (JP)

(21) Appl. No.: 16/510,017

(22) Filed: Jul. 12, 2019

(30) Foreign Application Priority Data
Jul. 31, 2018 (JP) 2018-143695

(51) Int. Cl. G02B 6/38; G02B 6/42; G02B 6/43

(52) U.S. Cl. CPC G02B 6/3814; G02B 6/4257; G02B 6/43; G02B 6/4269; G02B 6/4284

(57) ABSTRACT

An optical module includes a board having a first surface and a second surface, an electronic device mounted on the first surface, a first cover that covers the first surface of the board, a second cover that covers the second surface of the board, a first heat dissipation member disposed between the board and the second cover, and a second heat dissipation member disposed between the first cover and the second cover.

### CROSS-REFERENCE TO RELATED APPLICATIONS

This application is based on and claims priority to Japanese Patent Application No. 2018-143695, filed on Jul. 31, 2018, the entire contents of which are incorporated herein by reference.

### BACKGROUND OF THE INVENTION

### 1. Field of the Invention

The disclosures herein generally relate to an optical module.

### 2. Description of the Related Art

A quad small form-factor pluggable (QSFP) optical module in compliance with the QSFP standard, which is an interface standard for optical communications, includes an optical module in which a light emitter and a light receiver are mounted.

A driver for driving the light emitter may generate large amount of heat when driving the light emitter. The circuit board is covered by a top cover and a bottom cover. Thus, it would be desirable to have an optical module that can efficiently dissipate heat.

### RELATED-ART DOCUMENTS

### Patent Document 1: Japanese Patent No. 5280742

### Patent Document 2: Japanese Laid-open Patent Publication No. 2013-140208

### Patent Document 3: Japanese Laid-open Patent Publication No. 6-245542

### Patent Document 4: Japanese Laid-open Patent Publication No. 2014-93361

### SUMMARY

According to at least one embodiment, an optical module includes a board having a first surface and a second surface, an electronic device mounted on the first surface, a first cover that covers the first surface of the board, a second cover that covers the second surface of the board, a first heat dissipation member disposed between the board and the second cover, and a second heat dissipation member disposed between the first cover and the second cover.

### BRIEF DESCRIPTION OF THE DRAWINGS

FIG. 1 is a perspective view of an optical module;

FIG. 2 is a cross-sectional view of the optical module;

FIG. 3 is a perspective view of an optical module according to an embodiment of the present invention;

FIG. 4 is an exploded perspective view of the optical module according to the embodiment;

FIG. 5 is a cross-sectional view of the optical module according to the embodiment;

FIG. 6 illustrates a printed circuit board;

FIG. 7 is a perspective view of the inside of a first cover;

FIG. 8 is a perspective view of the inside of a second cover;

FIG. 9 is a top view of the optical module;

FIG. 10 is a top view of the optical module;

FIG. 11 is a cross-sectional view of the optical module;

FIG. 12 is a cross-sectional view of the optical module; and

FIG. 13 illustrates a variation of the optical module.

### DESCRIPTION OF THE EMBODIMENTS

According to an embodiment, an optical module that efficiently dissipates heat generated by electronic devices is provided.

In the following, embodiments of the present invention will be described with reference to the accompanying drawings. The same elements are denoted by the same reference numerals, and a description thereof will be omitted.

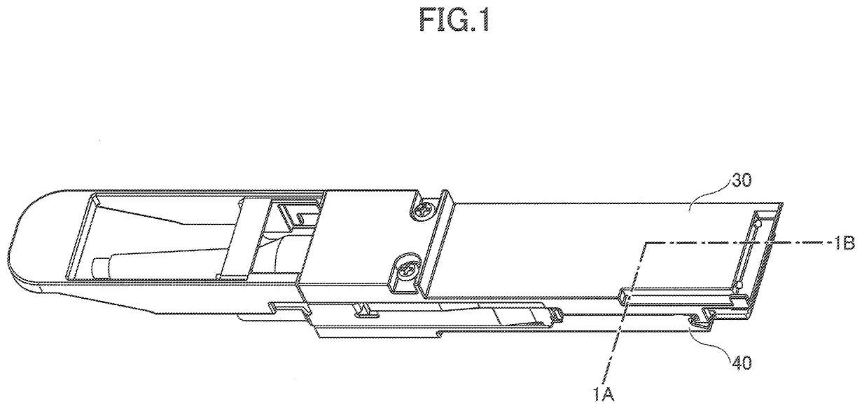

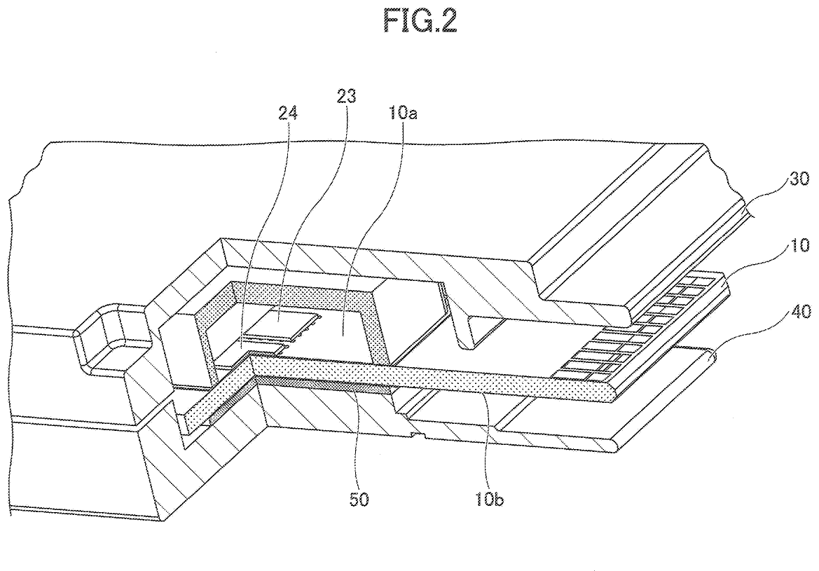

FIG. 1 is a perspective view of an optical module. FIG. 2 is a cross-sectional view of the optical module taken through a line 1A-1B of FIG. 1.

In the optical module illustrated in FIG. 2, a light emitter such as a vertical-cavity surface-emitting laser (VCSEL), a light receiver such as a photodiode, a driver 23, and a transimpedance amplifier (TIA) 24 are bonded to a surface 10a of a circuit board 10. The driver 23 drives the light emitter. TIA 24 converts a current signal output from the light receiver into a voltage signal. The light emitter, the light receiver, the driver 23, and the TIA 24 may be referred to as electronic devices.

The circuit board 10 is covered by a first cover 30 and a second cover 40. When the optical module is driven, the electronic devices generate heat, with heat generated by the driver 23 and the TIA 24 being rather significant. A heat dissipation member 50 is provided between the circuit board 10 and the second cover 40. Heat generated by the driver 23 and the TIA 24 is transferred from the surface 10b through the heat dissipation member 50 to the second cover 40, and is dissipated. The second cover 40 may be formed of a metal such as zinc die casting, and thus has high thermal conductivity.

However, if heat generated by the electronic devices is large, heat would not be sufficiently dissipated. Thus, an optical module that can dissipate heat more efficiently is desired.

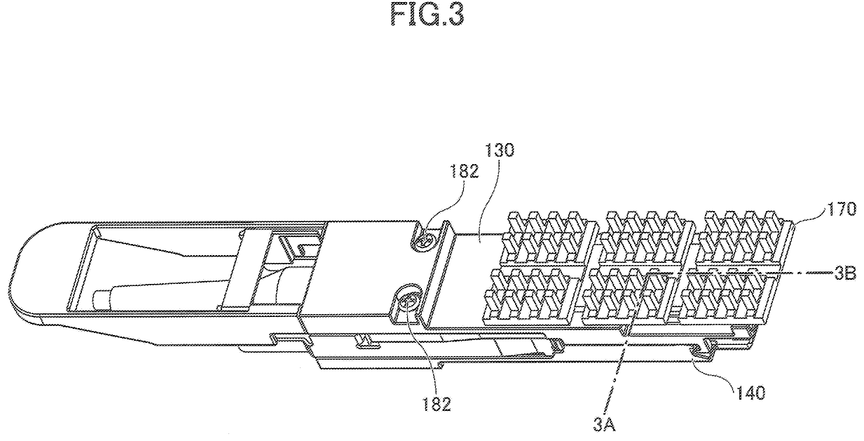

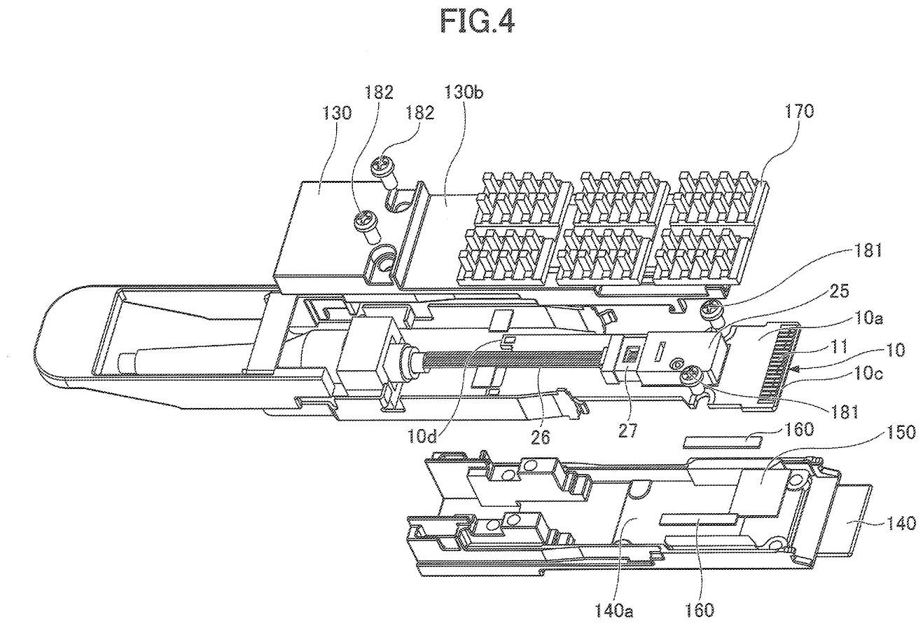

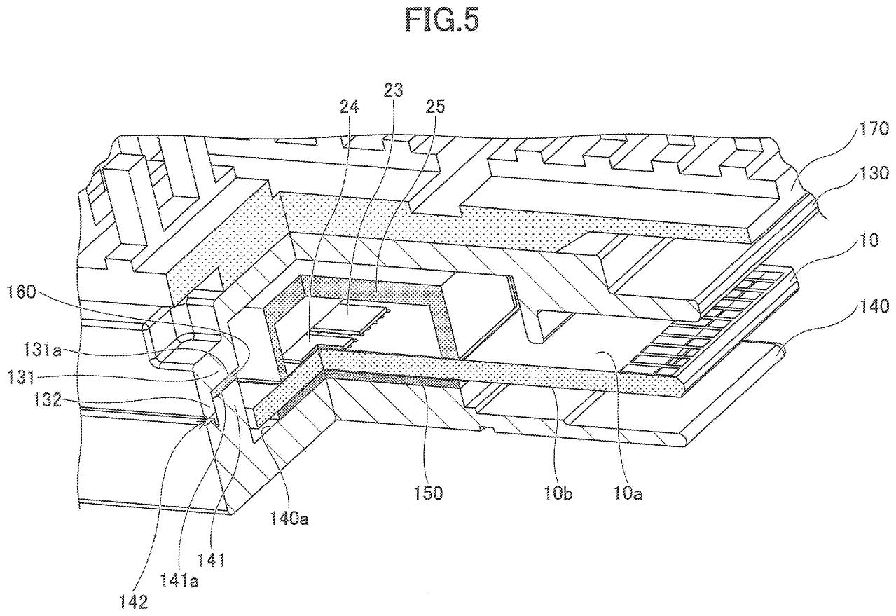

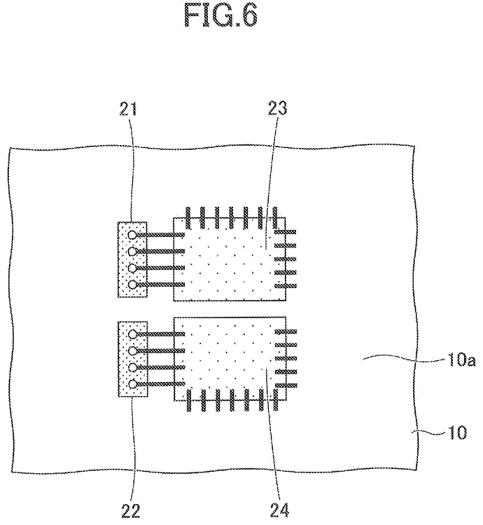

An optical module according to an embodiment of the present invention is described with reference to FIG. 3 through FIG. 6. FIG. 3 is a perspective view and FIG. 4 is an exploded perspective view of an optical module according to the embodiment. FIG. 5 is a cross-sectional view of the optical module taken through a line 3A-3B of FIG. 3. FIG. 6 is a top view of a circuit board.

The optical module includes a circuit board 10, a first cover 130 which is a top cover, a second cover 140 which is a bottom cover, a first heat dissipation member 150 and second heat dissipation members 160 formed of materials having high thermal conductivity and flexibility, and a heat sink 170.

As illustrated in FIG. 6, a light emitter 21 such as a VCSEL, a light receiver 22 such as a photodiode, a driver 23, and a TIA 24 are bonded to a surface 10a of the circuit board 10. As illustrated in FIG. 4 and FIG. 5, the electronic devices are covered by a lens member 25 having lenses.

The lens member 25 is connected to an MT ferrule 27 to which an optical cable 26 is connected. Light propagating through the optical cable 26 enters the lens member 25 through the MT ferrule 27. Light incident on the lenses is collected by the lenses, and enters the light receiver 22. Light emitted from the light emitter 21 is collected by the lenses and enters the optical cable 26 through the MT ferrule 27.

The first cover 130 and the second cover 140 forming a housing of the optical module are formed of zinc die castings. The first cover 130 covers the surface 10a, and the second cover 140 covers the surface 10b of the circuit board 10. A heat sink 170 formed of aluminum or the like is attached to an outer surface 130b of the first cover 130. The first heat dissipation member 150 and the second heat dissipation members 160 are collectively referred to as heat dissipation sheets.

The circuit board 10 is fixed to the second cover 140 using screws 181 with the first heat dissipation member 150 being sandwiched between an inner surface 140a of the second cover 140 and the surface 10b. By fixing the circuit board 10 to the second cover 140, the surface 140a and the surface 10b come into contact with the first heat dissipating member 150. The first heat dissipation member 150 is in contact with the circuit board 10 in an area of the surface 10b corresponding to an area of the surface 10a on which the electronic devices are mounted. Accordingly, heat generated by the electronic devices can be efficiently transferred to the second cover 140 through the first heat dissipation member 150.

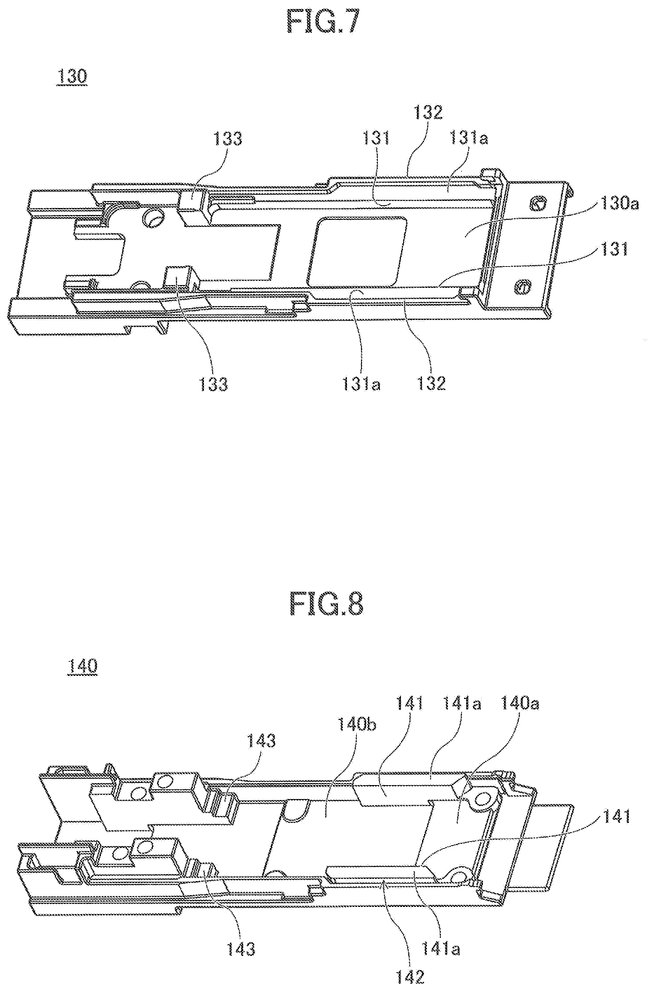

The second heat dissipation members 160 are provided between the first cover 130 and the second cover 140. As illustrated in FIG. 7, thermally conductive regions 131 are formed at both sides of a surface 130a of the first cover 130. As illustrated in FIG. 8, thermally conductive regions 141 are formed at both sides of a surface 140a and of a surface 140b of the second cover 140. The first cover 130 is fixed to the second cover 140 using screws 182, with the second heat dissipation members 160 being sandwiched between contact surfaces 131a of the regions 131 and contact surfaces 141a of the regions 141. By fixing the first cover 130 to the second cover 140, the contact surfaces 141a and the contact surfaces 131a come into contact with the second heat dissipation members 160.

As illustrated in FIG. 5, heat generated by the driver 23 and the TIA 24 is transferred to the surface 10b through the circuit board 10, and is transferred to the second cover 140 through the first heat dissipation member 150 contacting the surface 10b. Because the second cover 140 is formed of a zinc die casting having a relatively high thermal conductivity, heat is transferred to the regions 141 while being diffused, and is further transferred from the contact surfaces 141a through the second heat dissipation members 160 and the contact surfaces 131a to the first cover 130. The first cover 130 is also formed of a zinc die casting, heat is thus transferred to and is dissipated from the heat sink 170 attached to the surface 130b.

According to the present embodiment, heat generated by the electronic devices can be efficiently dissipated.

The first cover 130 is provided with projections 132 projecting toward the second cover 140, and the second cover 140 is provided with recesses 142 having shapes corresponding to the shapes of the projections 132. The lower surface of each projection 132 extends to a position lower than a corresponding contact surface 131a. By forming the projections 132 and the recesses 142, it is possible to prevent the second heat dissipation members 160 from protruding outwardly from the first cover 130 and the second cover 140. The projections 132 may have a height of approximately 1 mm.

In the above-described example, the projections 132 are formed on the first cover 130 and the recesses 142 are formed on the second cover 140. However, projections projecting toward the first cover 130 may be formed on the second cover 140, and recesses may be formed on the first cover 130. In this case, the upper surface of each of the projections extends to a position higher than a corresponding contact surface 141a.

It is preferable to provide the second heat dissipation members 160 for transferring heat generated by the electronic devices as close as possible to the electronic devices.

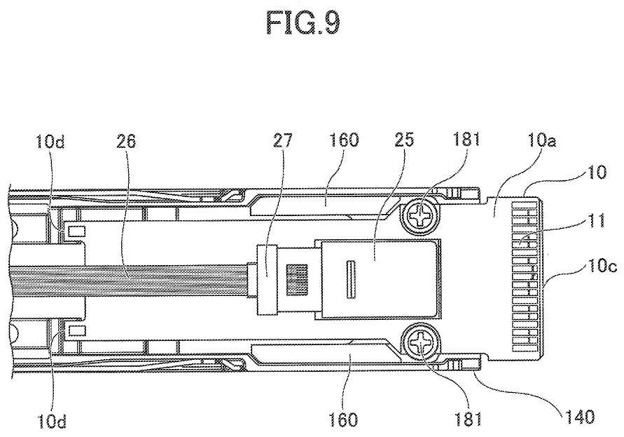

As illustrated in FIG. 9, the circuit board 10 is fixed to the second cover 140 with two screws 181. In order to secure places to dispose the second heat dissipation members 160, the circuit board 10 is fixed at positions close to an end 10c of the circuit board 10 on which a terminal 11 is provided. The circuit board 10 is fixed on the side closer to the terminal 11 relative to the center of the first heat dissipation member 150. Because the first heat dissipation member 150 is flexible, if the circuit board 10 is fixed at the above-described positions, the first heat dissipation member 150 would not be evenly pressed, causing the other end 10d of the circuit board 10 to rise.

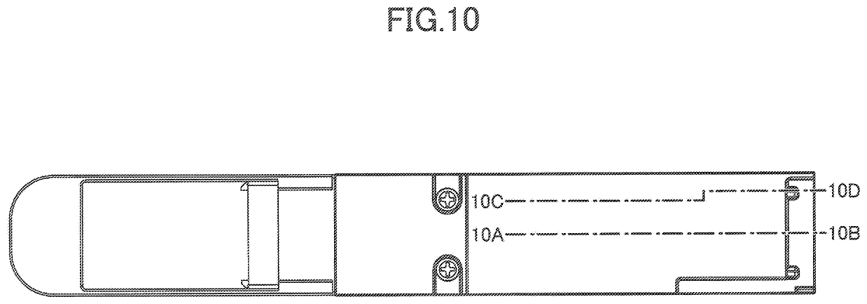

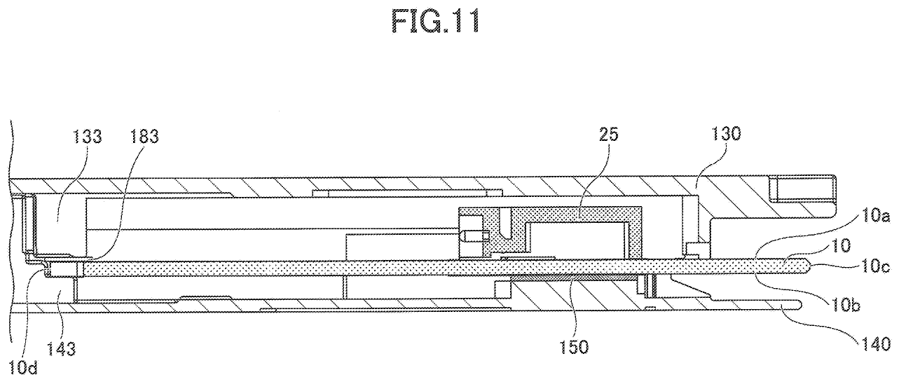

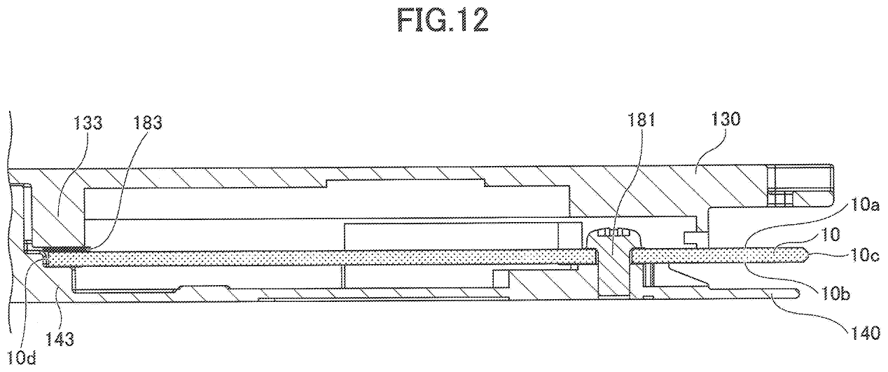

According to the present embodiment, the first cover 130 has supports 133 and the second cover 140 has supports 143 as illustrated in FIG. 7 and FIG. 8, both of which are provided to support the end 10d. FIG. 10 is a top view of the optical module in which the heat sink 170 is removed. FIG. 11 is a cross-sectional view of the optical module taken through a line 10A-10B of FIG. 10, and FIG. 12 is a cross-sectional view of the optical module taken through a line 10C-10D of FIG. 10.

The end 10c is fixed to the second cover 140 with the screws 181. The other end 10d is supported and fixed by being interposed between the supports 133 and the supports 143, with an elastic buffer 183 such as a heat dissipation member being placed between the circuit board 10 and the supports 133 as illustrated in FIG. 11 and FIG. 12. Accordingly, the end 10d does not rise when the circuit board 10 is fixed to the second cover 140 with the screws 181.

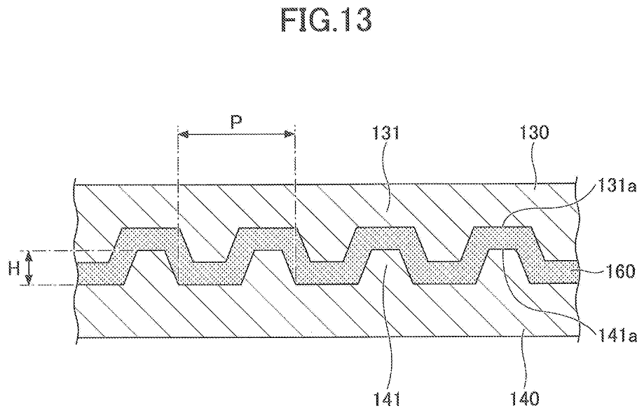

The contact surfaces 131a and the contact surfaces 141a may be flat, or may have irregularities as illustrated in FIG. 13. By forming irregularities on the contact surfaces 131a and 141a, it is possible to increase contact areas between the contact surfaces 131a and the second heat dissipation members 160, and contact areas between the contact surfaces 141a and the second heat dissipation members 160. Accordingly, the efficiency of heat transfer from the second cover 140 to the first cover 130 through the second heat dissipation members 160 can be further enhanced. The contact surfaces 131a and 141a may be formed such that a height H of each protrusion is approximately 0.5 mm, with a pitch P of the irregularities of approximately 1.0 mm.

The present invention is not limited to the above-described embodiments. Variations and modifications may be made to the described subject matter without departing from the scope of the invention as set forth in the accompanying claims.

What is claimed is:

1. An optical module comprising:
a board having a first surface and a second surface;
an electronic device mounted on the first surface;
a first cover that covers the first surface of the board;
a second cover that covers the second surface of the board;
a first heat dissipation member disposed between the board and the second cover; and
a second heat dissipation member disposed between the first cover and the second cover.

2. The optical module according to claim 1, wherein a heat sink is disposed on an outer surface of the first cover.

3. The optical module according to claim 1, wherein one end of the board is fixed to the second cover with a fixing member and another end of the board is fixed by being interposed between the first cover and the second cover.

4. The optical module according to claim 1, wherein the first cover and the second cover have contact surfaces in contact with the second heat dissipation member, one of the contact surfaces has a projection, and another one of the contact surfaces has a recess having a shape corresponding to a shape of the projection.
